(19) United States
(12) Patent Application Publication
(10) Pub. No.: US 2014/0355668 A1
(43) Pub. Date: Dec. 4, 2014

(54) Method and System for Controlling Video Frame Encoding

(71) Applicant: I.C.V.T. LTD., Tel Aviv (IL)

(72) Inventors: Sharon Carmel, Ramat Hasharon (IL); Dror Gill, Haifa (IL); Tamar Shoham, Netanya (IL); Amir Leibman, Netanya (IL)

(21) Appl. No.: 14/373,822

(22) PCT Filed: Jan. 2, 2013
(86) PCT No.: PCT/IL2013/050002

§ 371 Date: Jul. 22, 2014

Related U.S. Application Data
(60) Provisional application No. 61/589,534, filed on Jan. 23, 2012.

(51) Int. Cl. H04N 19/172; H04N 19/136; H04N 19/102

(52) U.S. Cl. CPC H04N 19/00266; H04N 19/00012; H04N 19/00139
USPC 375/240.02

(57) ABSTRACT

A method of enabling iterative encoding of a video frame by a video encoder, comprising obtaining a video-encoder-state resulting from encoding of a previous input video frame and previous to encoding of a current input video frame, copying the video-encoder-state giving rise to a reserved state and obtaining a candidate current encoded video frame from the video encoder, and in case the candidate current encoded video frame does not meet an encoding criterion, copying the reserved state back to the video encoder to enable the video encoder to re-encode the current input video frame.

### FIELD OF THE INVENTION

The present invention is in the field of video encoding and in particular controlling the encoding of video frames.

### SUMMARY OF THE INVENTION

Many of the functional components of the presently disclosed subject matter can be implemented in various forms, for example, as hardware circuits comprising custom VLSI circuits or gate arrays, or the like, as programmable hardware devices such as FPGAs or the like, or as a software program code stored on an intangible computer readable medium and executable by various processors, and any combination thereof. A specific component of the presently disclosed subject matter can be formed by one particular segment of software code, or by a plurality of segments, which can be joined together and collectively act or behave according to the presently disclosed limitations attributed to the respective component. For example, the component can be distributed over several code segments such as objects, procedures, and functions, and can originate from several programs or program files which operate in conjunction to provide the presently disclosed component.

In a similar manner, a presently disclosed component(s) can be embodied in operational data or operation data can be used by a presently disclosed component(s). By way of example, such operational data can be stored on tangible computer readable medium. The operational data can be a single data set, or it can be an aggregation of data stored at different locations, on different network nodes or on different storage devices.

The method or apparatus according to the subject matter of the present application can have features of different aspects described above or below, or their equivalents, in any combination thereof, which can also be combined with any feature or features of the method or apparatus described in the Detailed Description presented below, or their equivalents.

An aspect of the present disclosure relates to a method of and a device for enabling iterative encoding of a video frame by a video encoder. According to examples of the presently disclosed subject matter, the device for enabling iterative encoding of a video frame by a video encoder can include: a video-encoder-state access module, a video-encoder-state copy module, and an encoding evaluation module. The video-encoder-state access module can be adapted to obtain a video encoder-state resulting from encoding of a previous input video frame and previous to encoding of a current input video frame. The video-encoder-state copy module can be configured for copying the video-encoder-state giving rise to a reserved state. The encoding evaluation module can be adapted to obtain a candidate current encoded video frame for evaluating the quality thereof using an encoding criterion, and in case the candidate current encoded video frame does not meet an encoding criterion, the video-encoder-state copy module can be configured to copy the reserved state back to the video encoder to enable the video encoder to re-encode the current input video frame.

By way of example, the device can further include an encoding parameter configuration module. The encoding parameter configuration module can be adapted to configure the encoder to re-encode the current input video frame using different encoding parameters than the encoding parameters that were used to obtain the candidate current encoded video frame.

According to examples of the presently disclosed subject matter, the method of enabling iterative encoding of a video frame by a video encoder can include: obtaining a video-encoder-state resulting from encoding of a previous input video frame and previous to encoding of a current input video frame; copying the video encoder-state giving rise to a reserved state; and obtaining a current encoded video frame from the video encoder, and in case the candidate current encoded video frame does not meet an encoding criterion, copying the reserved state back to the video encoder to enable the video encoder to re-encode the current input video frame.

By way of example, the method can further include configuring the encoder to re-encode the current input video frame using different encoding parameters than the encoding parameters that were used to obtain the candidate current encoded video frame.

A further aspect of the present disclosure relates to a device for and a method of enabling parallel encoding of a video frame. According to examples of the presently disclosed subject matter, the device for enabling parallel encoding of a video frame can include a video-encoder-state access module, a video-encoder-state copy module, and an encoding evaluation module. The video-encoder-state access module can be adapted to obtain a video-encoder-state resulting from encoding of a previous input video frame and previous to encoding of a current input video frame. The video-encoder-state copy module can be configured for copying the video encoder-state to each one of a plurality of video encoders. The encoding evaluation module can be adapted to obtain a candidate current encoded video frame from each one of the plurality of video encoders, giving rise to a plurality of candidate current encoded video frames, and can be further adapted to select a current encoded video frame from the plurality of candidate current encoded video frames according to an encoding criterion.

According to examples of the presently disclosed subject matter for a subsequent input video frame:

The video-encoder-state access module can be adapted to obtain from the video encoder that provided the selected current encoded video frame, the video encoder-state resulting from encoding of the selected current input video frame, and previous to encoding of the subsequent input video frame;

The video-encoder-state copy module can be configured to copy, to each one of a plurality of video encoders, the video-encoder-state resulting from encoding of the selected current input video frame; and

The encoding evaluation module can be adapted to obtain a subsequent candidate encoded video frame from each one of the plurality of video encoders, giving rise to a plurality of subsequent candidate encoded video frames, and can be further adapted to select a subsequent encoded video frame from the plurality of subsequent candidate encoded video frames according to an encoding criterion.

By way of example, the device can further include an encoding parameter configuration module. The encoding parameter configuration module can be adapted to configure each one of the plurality of video encoders to use different encoding parameters for encoding the current input video frame.

According to examples of the presently disclosed subject matter, the method of enabling parallel encoding of a video frame can include: obtaining a video encoder-state resulting from encoding of a previous input video frame and previous to encoding of a current input video frame; copying the video-encoder-state to each one of a plurality of video encoders; obtaining a candidate current encoded video frame from each one of the plurality of video encoders, giving rise to a plurality of candidate current encoded video frames; and selecting a current encoded video frame from the plurality of candidate current encoded video frames according to an encoding criterion.

By way of example, for a subsequent input video frame, the method can include: obtaining, from the video encoder that provided the selected current encoded video frame, the video-encoder-state resulting from encoding of the current input video frame; previous to encoding of the subsequent input video frame, copying to each one of a plurality of video encoders, the video-encoder-state resulting from encoding of the current input video frame; obtaining a subsequent candidate encoded video frame from each one of the plurality of video encoders, giving rise to a plurality of subsequent candidate encoded video frames; and selecting a subsequent encoded video frame from the plurality of subsequent candidate encoded video frames according to an encoding criterion.

By way of example, the method can further include configuring each one of the plurality of video encoders to use different encoding parameters for encoding the current input video frame.

According to a further aspect of the presently disclosed subject matter, there is provided a program storage device readable by machine, tangibly embodying a program of instructions executable by the machine to perform a method of enabling iterative encoding of a video frame by a video encoder. According to examples of the presently disclosed subject matter, the program storage device can include instructions for: obtaining a video-encoder-state resulting from encoding of a previous input video frame and previous to encoding of a current input video frame; copying the video-encoder-state giving rise to a reserved state; and obtaining a candidate current encoded video frame from the video encoder, and in case the candidate current encoded video frame does not meet an encoding criterion, copying the reserved state back to the video encoder to enable the video encoder to re-encode the current input video frame.

In accordance with still a further aspect of the presently disclosed subject matter, there is provided a computer program product comprising a computer useable medium having computer readable program code embodied therein of enabling iterative encoding of a video frame by a video encoder. According to examples of the presently disclosed subject matter, the computer program product can include: computer readable program code for causing the computer to obtain a video-encoder-state resulting from encoding of a previous input video frame and previous to encoding of a current input video frame; computer readable program code for causing the computer to copy the video-encoder-state giving rise to a reserved state; and computer readable program code for causing the computer to obtain a candidate current encoded video frame from the video encoder, and in case the candidate current encoded video frame does not meet an encoding criterion, copying the reserved state back to the video encoder to enable the video encoder to re-encode the current input video frame.

In yet a further aspect of the presently disclosed subject matter, there is provided a program storage device readable by machine, tangibly embodying a program of instructions executable by the machine to perform a method of enabling parallel encoding of a video frame. According to examples of the presently disclosed subject matter the program storage device can include instructions for: obtaining a video-encoder-state resulting from encoding of a previous input video frame and previous to encoding of a current input video frame; copying the video-encoder state to each one of a plurality of video encoders; obtaining a candidate current encoded video frame from each one of the plurality of video encoders, giving rise to a plurality of candidate current encoded video frames; and selecting a current encoded video frame from the plurality of candidate current encoded video frames according to an encoding criterion.

In still a further aspect of the currently disclosed subject matter there is provided a computer program product comprising a computer useable medium having computer readable program code embodied therein of enabling parallel encoding of a video frame. According to examples of the presently disclosed subject matter the computer program product can include computer readable program code for causing the computer to obtain a video-encoder-state resulting from encoding of a previous input video frame and previous to encoding of a current input video frame; computer readable program code for causing the computer to copy the video-encoder-state to each one of a plurality of video encoders; computer readable program code for causing the computer to obtain a candidate current encoded video frame from each one of the plurality of video encoders, giving rise to a plurality of candidate current encoded video frames; and computer readable program code for causing the computer to select a current encoded video frame from the plurality of candidate current encoded video frames according to an encoding criterion.

According to a further aspect of the presently disclosed subject matter, there is provided a method of enabling iterative encoding of a group of video frames by a video encoder. According to examples of the presently disclosed subject matter, the method of enabling iterative encoding of a group of video frames by a video encoder can include: obtaining a video-encoder-state resulting from encoding of a previous input video frame and previous to encoding of a first input video frame from a group of input video frames; copying the video-encoder-state giving rise to a reserved state; and obtaining a group of candidate current encoded video frames, which correspond to the group of input video frames, from the video encoder, and in case the candidate current encoded video frames do not meet an encoding criterion, copying the reserved state back to the video encoder to enable the video encoder to re-encode the group of input video frames.

According to still a further aspect of the presently disclosed subject matter there is provided a method of enabling parallel encoding of a group of video frames.

According to examples of the presently disclosed subject matter, the method of enabling parallel encoding of a group of video frames can include: obtaining a video encoder-state resulting from encoding of a previous input video frame and previous to encoding of a first input video frame from a group of input video frames; copying the video-encoder-state to each one of a plurality of video encoders; obtaining a group of candidate current encoded video frames, which correspond to the group of input video frames, from each one of the plurality of video encoders, giving rise to a plurality of groups of candidate current encoded video frames; and selecting a group of current encoded video frames from the plurality of groups of candidate current encoded video frames according to an encoding criterion.

In yet a further aspect of the presently disclosed subject matter there is provided a device for enabling iterative encoding of a group of video frames by a video encoder. According to examples of the presently disclosed subject matter the device for enabling iterative encoding of a group of video frames by a video encoder can include: a video-encoder-state access module, a video-encoder-state copy module and an encoding evaluation module. The video-encoder-state access module adapted to obtain a video-encoder-state resulting from encoding of a previous input video frame and previous to encoding of a first input video frame from a group of input video frames. The video-encoder-state copy module configured for copying the video-encoder-state giving rise to a reserved state. The encoding evaluation module adapted to obtain a group of candidate current encoded video frames, which correspond to the group of input video frames, for evaluating the quality thereof using an encoding criterion, wherein in case the group of candidate current encoded video frames does not meet an encoding criterion, the video-encoder-state copy module is configured to copy the reserved state back to the video encoder to enable the video encoder to re-encode the group of input video frames.

In still a further aspect of the presently disclosed subject matter, there is provided a device for enabling parallel encoding of a group of video frames. According to examples of the presently disclosed subject matter, the device for enabling parallel encoding of a group of video frames can include a video-encoder state access module, a video-encoder-state copy module and an encoding evaluation module. The video-encoder-state access module adapted to obtain a video encoder-state resulting from encoding of a previous input video frame and previous to encoding of a first input video frame from a group of input video frames. The video-encoder-state copy module configured for copying the video-encoder-state to each one of a plurality of video encoders. The encoding evaluation module adapted to obtain a group of candidate current encoded video frames, which correspond to the group of input video frames, from each one of the plurality of video encoders, giving rise to a plurality of groups of candidate current encoded video frames, and is further adapted to select a group of current encoded video frames from the plurality of groups of candidate current encoded video frames according to an encoding criterion.

In accordance with yet a further aspect of the presently disclosed subject matter, there is provided a program storage device readable by machine, tangibly embodying a program of instructions executable by the machine to perform a method of enabling iterative encoding of a group of video frames by a video encoder. According to examples of the presently disclosed subject matter, the program storage device can include instructions for: obtaining a video-encoder-state resulting from encoding of a previous input video frame and previous to encoding of a first input video frame from a group of input video frames copying the video encoder-state giving rise to a reserved state; and obtaining a group of candidate current encoded video frames, which correspond to the group of input video frames, from the video encoder, and in case the candidate current encoded video frames do not meet an encoding criterion, copying the reserved state back to the video encoder to enable the video encoder to re-encode the group of input video frames.

In accordance with still a further aspect of the presently disclosed subject matter, there is provided a computer program product comprising a computer useable medium having computer readable program code embodied therein of enabling iterative encoding of a group of video frames by a video encoder.

According to examples of the presently disclosed subject matter, the computer program product can include: computer readable program code for causing the computer to obtain a video-encoder-state resulting from encoding of a previous input video frame and previous to encoding of a first input video frame from a group of input video frames; computer readable program code for causing the computer to copy the video-encoder-state giving rise to a reserved state; and computer readable program code for causing the computer to obtain a group of candidate current encoded video frames, which correspond to the group of input video frames, from the video encoder, and in case the candidate current encoded video frames do not meet an encoding criterion, copying the reserved state back to the video encoder to enable the video encoder to re-encode the group of input video frames.

According to a further aspect of the presently disclosed subject matter, there is provided a program storage device readable by machine, tangibly embodying a program of instructions executable by the machine to perform a method of enabling parallel encoding of a group of video frames. According to examples of the presently disclosed subject matter, the program storage device can include instructions for: obtaining a video-encoder-state resulting from encoding of a previous input video frame and previous to encoding of a first input video frame from a group of input video frames; copying the video-encoder-state to each one of a plurality of video encoders; obtaining a group of candidate current encoded video frames, which correspond to the group of input video frames, from each one of the plurality of video encoders, giving rise to a plurality of groups of candidate current encoded video frames; and selecting a group of current encoded video frames from the plurality of groups of candidate current encoded video frames according to an encoding criterion.

In accordance with still a further aspect of the presently disclosed subject matter, there is provided a computer program product comprising a computer useable medium having computer readable program code embodied therein of enabling parallel encoding of a group of video frames. According to examples of the presently disclosed subject matter, the computer program product can include:

computer readable program code for causing the computer to obtain a video encoder-state resulting from encoding of a previous input video frame and previous to encoding of a first input video frame from a group of input video frames; computer readable program code for causing the computer to copy the video-encoder-state to each one of a plurality of video encoders; computer readable program code for causing the computer to obtain a group of candidate current encoded video frames, which correspond to the group of input video frames, from each one of the plurality of video encoders, giving rise to a plurality of groups of candidate current encoded video frames; and computer readable program code for causing the computer to select a group of current encoded video frames from the plurality of groups of candidate current encoded video frames according to an encoding criterion.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram illustration of a device for enabling iterative encoding of a video frame by a video encoder, according to examples of the presently disclosed subject matter;

FIG. 2 is a flowchart illustration of a method of enabling iterative encoding of a video frame by a video encoder, according to examples of the presently disclosed subject matter;

FIG. 3 is a block diagram illustration of a device for enabling parallel encoding of a video frame, according to examples of the presently disclosed subject matter;

FIG. 4 is a flowchart illustration of a method of enabling parallel encoding of a video frame, according to examples of the presently disclosed subject matter;

FIG. 5 is a flowchart illustration of enabling parallel encoding of a video frame, according to examples of the presently disclosed subject matter;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures and components have not been described in detail so as not to obscure the presently disclosed subject matter.

Unless specifically stated otherwise, as apparent from the following discussions, it is appreciated that throughout the specification discussions various functional terms refer to the action and/or processes of a computer or computing device, or similar electronic computing device, that manipulate and/or transform data represented as physical, such as electronic, quantities within the computing device's registers and/or memories into other data similarly represented as physical quantities within the computing device's memories, registers or other such tangible information storage, transmission or display devices.

An aspect of the present disclosure relates to a method of and a device for enabling iterative encoding of a video frame by a video encoder. According to examples of the presently disclosed subject matter, the device for enabling iterative encoding of a video frame by a video encoder can include: a video-encoder-state access module, a video-encoder-state copy module, and an encoding evaluation module. The video-encoder-state access module can be adapted to obtain a video encoder-state resulting from encoding of a previous input video frame and previous to encoding of a current input video frame. The video-encoder-state copy module can be configured for copying the video-encoder-state giving rise to a reserved state.

The encoding evaluation module can be adapted to obtain a candidate current encoded video frame for evaluating the quality thereof using an encoding criterion, and in case the candidate current encoded video frame does not meet an encoding criterion, the video-encoder-state copy module can be configured to copy the reserved state back to the video encoder to enable the video encoder to re-encode the current input video frame.

By way of example, the device can further include an encoding parameter configuration module. The encoding parameter configuration module can be adapted to configure the encoder to re-encode the current input video frame using different encoding parameters than the encoding parameters that were used to obtain the candidate current encoded video frame.

According to examples of the presently disclosed subject matter, the method of enabling iterative encoding of a video frame by a video encoder can include:

obtaining a video-encoder-state resulting from encoding of a previous input video frame and previous to encoding of a current input video frame; copying the video encoder-state giving rise to a reserved state; and obtaining a current encoded video frame from the video encoder, and in case the candidate current encoded video frame does not meet an encoding criterion, copying the reserved state back to the video encoder to enable the video encoder to re-encode the current input video frame.

By way of example, the method can further include configuring the encoder to re-encode the current input video frame using different encoding parameters than the encoding parameters that were used to obtain the candidate current encoded video frame.

A further aspect of the present disclosure relates to a device for and a method of enabling parallel encoding of a video frame. According to examples of the presently disclosed subject matter, the device for enabling parallel encoding of a video frame can include a video-encoder-state access module, a video-encoder-state copy module, and an encoding evaluation module. The video-encoder-state access module can be adapted to obtain a video-encoder-state resulting from encoding of a previous input video frame and previous to encoding of a current input video frame.

The video-encoder-state copy module can be configured for copying the video encoder-state to each one of a plurality of video encoders. The encoding evaluation module can be adapted to obtain a candidate current encoded video frame from each one of the plurality of video encoders, giving rise to a plurality of candidate current encoded video frames, and can be further adapted to select a current encoded video frame from the plurality of candidate current encoded video frames according to an encoding criterion.

According to examples of the presently disclosed subject matter for a subsequent input video frame:

The video-encoder-state access module can be adapted to obtain from the video encoder that provided the selected current encoded video frame, the video encoder-state resulting from encoding of the current input video frame, and previous to encoding of the subsequent input video frame;

The video-encoder-state copy module can be configured to copy, to each one of a plurality of video encoders, the video-encoder-state resulting from encoding of the current input video frame; and

The encoding evaluation module can be adapted to obtain a subsequent candidate encoded video frame from each one of the plurality of video encoders, giving rise to a plurality of subsequent candidate encoded video frames, and can be further adapted to select a subsequent encoded video frame from the plurality of subsequent candidate encoded video frames according to an encoding criterion.

By way of example, the device can further include an encoding parameter configuration module. The encoding parameter configuration module can be adapted to configure each one of the plurality of video encoders to use different encoding parameters for encoding the current input video frame.

According to examples of the presently disclosed subject matter, the method of enabling parallel encoding of a video frame can include: obtaining a video encoder-state resulting from encoding of a previous input video frame and previous to encoding of a current input video frame; copying the video-encoder-state to each one of a plurality of video encoders; obtaining a candidate current encoded video frame from each one of the plurality of video encoders, giving rise to a plurality of candidate current encoded video frames; and selecting a current encoded video frame from the plurality of candidate current encoded video frames according to an encoding criterion.

By way of example, for a subsequent input video frame, the method can include: obtaining, from the video encoder that provided the selected current encoded video frame, the video-encoder-state resulting from encoding of the current input video frame; previous to encoding of the subsequent input video frame, copying to each one of a plurality of video encoders, the video-encoder-state resulting from encoding of the current input video frame; obtaining a subsequent candidate encoded video frame from each one of the plurality of video encoders, giving rise to a plurality of subsequent candidate encoded video frames; and selecting a subsequent encoded video frame from the plurality of subsequent candidate encoded video frames according to an encoding criterion.

By way of example, the method can further include configuring each one of the plurality of video encoders to use different encoding parameters for encoding the current input video frame.

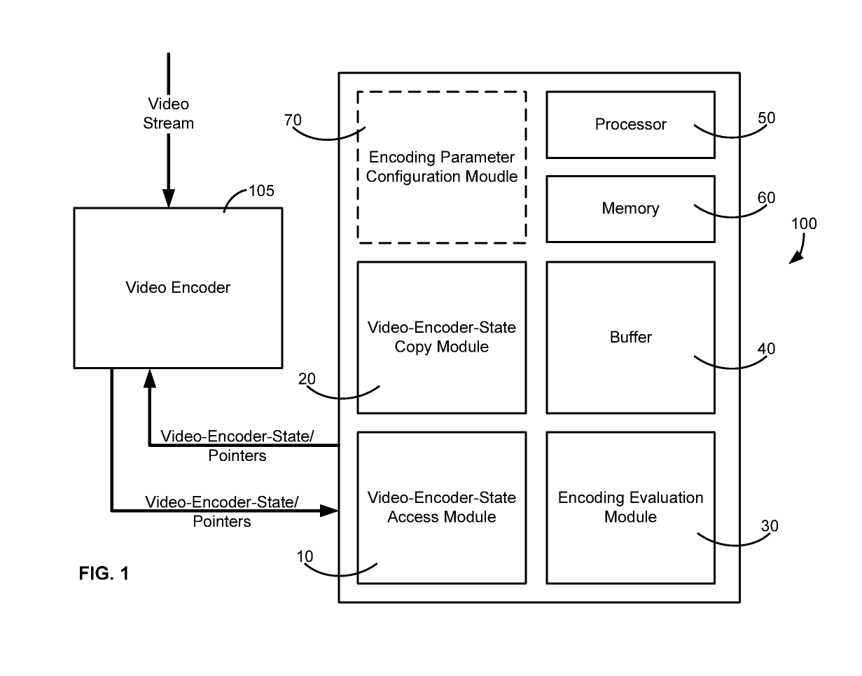

Turning now to FIG. 1, there is shown a block diagram illustration of a device for enabling iterative encoding of a video frame by a video encoder, according to examples of the presently disclosed subject matter. According to examples of the presently disclosed subject matter, the device 100 for enabling iterative encoding of a video frame by a video encoder 105 can include: a processor 50, a memory 60, a video-encoder-state access module 10, a video-encoder-state copy module 20, and an encoding evaluation module 30. The processor 50 and memory unit 60, in cooperation with the other components of the device 100, can be operable for initiating and/or executing the method of enabling iterative encoding of a video frame by a video encoder, as will be described herein. The processor 50 and memory 60 can be any commercially available or yet to be devised processing and memory units, respectively.

The video encoder 105 can be any presently available or yet to be devised video encoder, including but not limited to the following: H.264 video encoder, X.264 video encoder, H.261 video encoder, H.263 video encoder, MPEG-1 video encoder, MPEG-2 video encoder, MPEG-4 video encoder, WebM video encoder, VP8 video encoder, Adobe Flash video encoder, Sorenson video encoder, Main Concept video encoder.

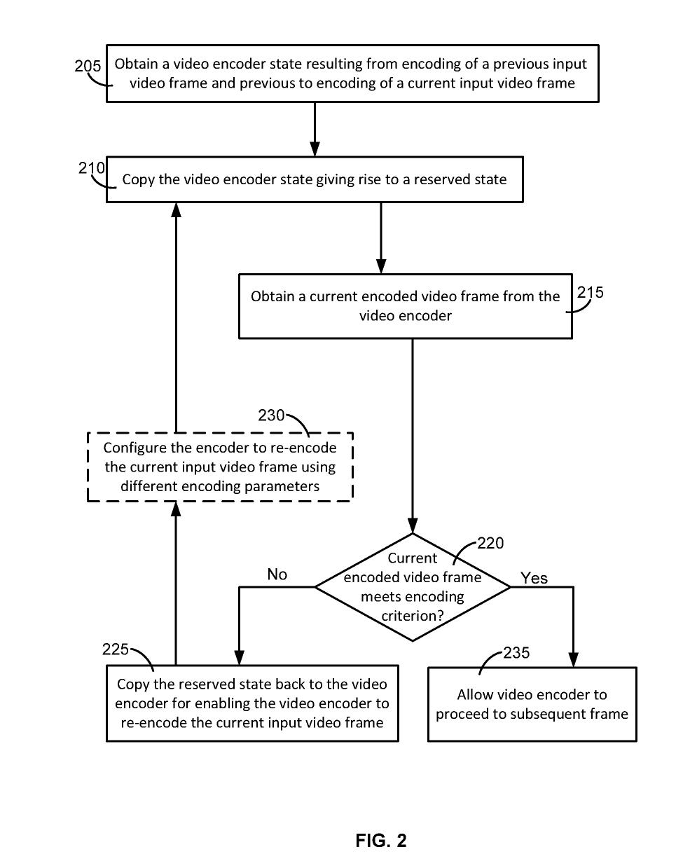

Reference is now additionally made to FIG. 2, which is a flowchart illustration of a method of enabling iterative encoding of a video frame by a video encoder, according to examples of the presently disclosed subject matter. According to examples of the presently disclosed subject matter, at some point during the encoding by the encoder 105 of a video stream, a video encoder state can be accessed, for example, using the video-encoder-state access module 10. According to an example of the presently disclosed subject matter, given a certain current input video frame, the video encoder state for the current input video frame can be accessed following the encoding of a previous input video frame and previous to encoding of the current input video frame (block 205). Thus, the video encoder state obtained or accessed for a certain current input video frame is the video encoder state resulting from encoding of a previous input video frame and previous to encoding of a current input video frame.

Obtaining the video encoder state can be performed, for example, by accessing the data structure which holds the encoder's state, or accessing a pointer to the data structure.

According to examples of the presently disclosed subject matter, the video encoder state can be copied (block 210). It should be noted, the for a given current input video frame, the copy operation provides a copy of the video encoder state resulting from encoding of a previous input video frame and previous to encoding of a current input video frame. For convenience, throughout the description and in the claims, the copy of the video encoder state of a given current input frame is referred to as “the reserved state”. According to examples of the presently disclosed subject matter, the video-encoder-state copy module 20 is responsible for creating the reserved state for the current input video frame.

Copying the video encoder state can be performed, for example, by copying the data structure which holds the encoder state to another data structure of the same type. Copying the data structure can be performed, for example, by a “Deep Copy” operation, in which: memory for a new data structure of the same type as the encoder's data structure is allocated; static data members are copied from the encoder's data structure to the new data structure; for dynamic data members of the encoder's data structure (data members which are pointers), new memory is allocated in the new data structure, and the content of memory pointed by the dynamic data members of the encoder's data structure is coped to the content of the new memory. Note that if the dynamic pointer of the encoder's data structure points to a structure, it is also copied using a “Deep Copy” operation recursively.

According to examples of the presently disclosed subject matter, the accessing of the video encoder state for the current input video frame can be implemented as a discrete operation together with the copying of the video encoder state for the current input video frame, and accessing and copying are not necessarily implemented as two separate operations. Furthermore, according to examples of the presently disclosed subject matter, one of the video-encoder-state access module 10 or the video-encoder-state copy module 20 can be redundant or the two components can be combined.

Continuing with the description of FIG. 2, at block 215, a candidate current encoded video frame can be obtained, e.g., from the encoder 105. The candidate current encoded video frame that is referred to here, is the current encoded version of the current input frame for which the reserved state was obtained at block 205 and was copied at block 210. As will be explained below, the process in FIG. 2 can enable an iterative encoding process, and at each iteration of the encoding process a different encoded video frame can be provided for a given input video frame, and therefore each encoded version of a given input frame that is to be or is evaluated as part of the method according to examples of the presently disclosed subject matter is referred to herein as a candidate current encoded video frame.

By way of example, the candidate current encoded video frame can be obtained by the encoding evaluation module 30, from the encoder 105. Obtaining the video encoder state can be performed, for example, by accessing the data structure which holds the encoder's state, or accessing a pointer to said data structure.

According to examples of the presently disclosed subject matter, the encoding evaluation module 30 can be configured to process the candidate current encoded video frame that was obtained from the video encoder 105, to determine whether it meets a predefined encoding criterion or not (block 220). According to examples of the presently disclosed subject matter, the encoding criterion can be associated with any one of the following: a video quality measure, a frame size in bits, a bit rate, number of Intra mode macroblocks, number of skipped macroblocks or combinations thereof.

According to an example of the presently disclosed subject matter, the predefined encoding criterion can set a certain value and define a desired relation, such that the candidate current encoded video frame that is to be selected from amongst the plurality of candidate current encoded video frames, is the one which presents the closest (or furthest, etc.) relation to the value.

According to examples of the presently disclosed subject matter, the evaluation of the candidate current encoded video frame can use the corresponding current input video frame as a reference. Various aspects of the candidate current encoded video frame can be compared with corresponding aspects of the current input video frame. The comparison can be carried out for example by the encoding evaluation module 30.

As mentioned above, according to examples of the presently disclosed subject matter, the encoding criterion can be associated with a video encoding quality measure, and possibly with a combination of a plurality of video quality measures. Examples of video encoding quality measures that can be used, for example by the encoding evaluation module 30, to evaluate a given candidate current encoded video frame include (but are not limited to) any one of the following video encoding quality measures: Peak Signal to Noise Ratio (PSNR), Structural Similarity (SSIM), Video Quality Metric (VQM), Moscow State University video quality (MSU), Picture Quality Scale (PQS), Perceptual Evaluation of Video Quality (PEVQ), the quality measure described in U.S. Provisional Application No. 61/528,361, filed on Aug. 29, 2011, the content of which is hereby incorporated herein in its entirety, or combinations thereof. The quality measure described in U.S. Provisional Application No. 61/528,361 is sometimes referred to herein as “BBvCQ”.

It would be appreciated that in some examples of the presently disclosed subject matter, any presently known or yet to be devised video encoding quality measure can be used as or as part of a video encoding quality measure.

Further by way of example, the evaluation of a given candidate current encoded video frame can use, in addition to the corresponding current input frame, a preceding encoded video frame and a preceding input video frame. Thus for example, the device 100 can include a buffer 40 in which, for a given candidate current encoded video frame, the corresponding current input frame, the preceding encoded video frame and the preceding input video frame can be held. An example of a video quality measure that is based on the processing of a given current (candidate) encoded frame, a corresponding current input frame, a preceding encoded video frame and a preceding input video frame is described in U.S. Provisional Application No. 61/528,361 filed on Aug. 29, 2011 (sometimes referred to herein as BBvCQ), the content of which is hereby incorporated herein in its entirety.

By way of example, at block 220 an aspect or various aspects of the candidate current encoded video frame, such as the ones associated with the quality measures and other encoding criteria mentioned above, can be quantified and a predefined threshold can be implemented to determine whether the candidate current encoded video frame meets the encoding criterion or not. Further by way of example, the quantification of the results of the comparison and the implementation of the predefined threshold to determine whether the candidate current encoded video frame meets the encoding criterion or not can be carried out by the encoding evaluation module 30.

According to examples of the presently disclosed subject matter, in case at block 220 it is determined that the candidate current encoded video frame does not meet the encoding criterion, the operation in block 225 is initiated. At block 225, the reserved state is copied back to the video encoder 105. The copying of the reserved state back to the video encoder 105 is intended to enable the video encoder 105 to re-encode the current input video frame. According to examples of the presently disclosed subject matter, the instruction to re-encode the current input frame following the copying of the reserved back to the video encoder 105 can be provided and the current frame can be re-encoded giving rise to a new candidate current encoded video frame.

According to examples of the presently disclosed subject matter, the copying of the reserved state back to the video encoder 105, can be carried out by the video encoder-state access module 10. Further by way of example, the video-encoder state access module 10 can obtain the reserved state from the video-encoder-state copy module 20, or from the memory 60 or from the buffer 40 in case the reserved state was temporarily stored there, and the video-encoder-state access module 10 can Copying the video encoder state can be performed, for example, by copying the data structure which holds the encoder state to another data structure of the same type. Copying the data structure can be performed for example by a “Deep Copy” operation, in which: memory for a new data structure of the same type as the encoder's data structure is allocated; static data members are copied from the encoder's data structure to the new data structure; for dynamic data members of the encoder's data structure (data members which are pointers), new memory is allocated in the new data structure, and the content of memory pointed by the dynamic data members of the encoder's data structure is copied to the content of the new memory. Note that if the dynamic pointer of the encoder's data structure points to a structure, it is also copied using a “Deep Copy” operation recursively.

According to examples of the presently disclosed subject matter, the video encoder 105 can be configured to re-encode the current input video frame using different encoding parameters than the encoding parameters that were used to obtain the current encoded video frame (block 230).

For example, the device 100 can include an encoding parameter configuration module 70 that is adapted to configure the video encoder 105 to re-encode the current input video frame using different encoding parameters than the encoding parameters that were used to obtain the candidate encoded video frame which failed to meet the encoding criterion at block 220. By way of example, the encoding parameter configuration module 70 can be adapted to obtain an encoding parameter(s) that were used in the encoding of the candidate current encoded video frame (that is the one that just failed to meet the encoding criterion), and the encoding parameter configuration module 70 can include logic that can be implemented for determining a different video encoding parameter, for example by adapting the encoding parameter(s) that were used in the encoding of the rejected candidate encoded video frame. The encoding parameter configuration module 70 can be adapted to configure the video encoder 105 to use, together with copied back reserved state, the selected video encoding parameters for re-encoding the current input frame, giving rise to a new candidate current encoded video frame.

According to examples of the presently disclosed subject matter, in case in a current iteration of the process, the candidate current encoded video frame was rejected, one or more of the following video encoding parameters can be modified at a subsequent iteration of encoding the current input frame (relative to the current iteration): Quantization Parameter (QP), encoding mode, frame type (I/B/P), Macroblock partitioning mode, Field/Frame mode (MBAFF), placement of intra macroblocks, number of reference frames, or any combination of the above parameters. It would be appreciated that the list of parameters provided herein is non-exhaustive.

The modified parameters are used to affect the encoder settings, prior to encoding the current input frame. This is generally done either via changing a relevant field in the encoder data structure, or by sending the modified parameter to the encoding process as a function parameter.

It would be appreciated that in further examples of the presently disclosed subject matter, the source of the modified encoding parameter, as well as the implementation of the logic for selecting the modified encoding parameter can be external to the device 100. In such a case, the device 100 provides the reserved state, and the modified encoding parameters can be (but are not necessarily) provided by some other device.

According to examples of the presently disclosed subject matter, copying the reserved state back to the video encoder 105 can enable the video encoder 105 to re-encode the current input video frame again using the same state of the video encoder 105 at the instant before the encoding of the current input video frame (and after the encoding of the previous input video frame), thus effectively rolling back the previous encoding iteration which resulted in an encoded frame that did not meet the predefined encoding criterion.

According to examples of the presently disclosed subject matter, blocks 210225, and possibly also block 230, can be implemented repeatedly or iteratively, until a candidate current encoded video frame meets the encoding criterion. When a candidate current encoded video frame, after one or more iterations (e.g., two, three, . . . , N iterations), meets the encoding criterion, the iterative process can end (block 235).

It would be appreciated, that according to examples of the presently disclosed subject matter, so long as a current encoded video frame does not meet the encoding criterion (in block 220), it is merely a candidate current encoded video frame, and if the candidate current encoded video frame does not meet the encoding criterion, the reserved state will be copied back to the video encoder 105, and the video encoder will re-encode the current input video frame, possibly using a different encoding parameter relative to the previous encoding iteration, and a new candidate current encoded video frame will be generated.

According to examples of the presently disclosed subject matter, when a candidate current encoded video frame meets the encoding criteria in block 220, the device 100 is configured not to copy the reserved state back to the encoder 105, thus allowing the candidate current encoded video frame to become the selected current encoded frame, and for example, the encoder 105 can provide as output the selected current encoded frame. In one example, when the device 100 stops intervening with the encoding process, the video encoder 105 will provide the candidate current encoded video frame as output (or as the current encoded video frame). It would be appreciated that according to examples of the presently disclosed subject matter, if necessary, the device 100 can indicate to the encoder 105 that it can resume the encoding of the video stream and does not need to wait for a reserved frame, or in further examples of the presently disclosed subject matter, the encoder 105 is configured such that when its state is not overwritten with the reserved state, e.g., within a certain duration from encoding of the current input frame, it can resume the encoding process and start encoding the subsequent input frame. Thus, following block 220, depending on whether the encoding criterion is met or not, the candidate current encoded video frame either becomes the selected current encoded video frame, or the encoder 105 is configured to provide a new candidate current encoded video frame.

According to examples of the presently disclosed subject matter, the selected current encoded video frames can be appended to the previously encoded frame(s), and is thus placed in the output bitstream.

According to examples of the presently disclosed subject matter, the process in FIG. 2, can be implemented for each input video frame from an input video frame stream.

However, in further examples of the presently disclosed subject matter, the process in FIG. 2 can also be implemented in respect to a group of input video frames each time, where the group consists of a plurality of video frames (e.g., two, three, . . . , N frames). In this implementation, a device for enabling iterative encoding of a group of video frames by a video encoder, which includes substantially the same components as the device for enabling iterative encoding of a video frame by a video encoder 100 can be used.

According to examples of the presently disclosed subject matter, a process of enabling iterative encoding of a group of video frames by a video encoder, can include an operation corresponding to block 205, where for a certain group of current input video frames, the video encoder state for the first input video frame in the group can be accessed following the encoding of a previous input video frame and previous to encoding of the first input video frame in the group. The video encoder state for the first input video frame in the group can be copied (an operation corresponding to block 210). These operations can be implemented substantially in the same manner as the implementation of blocks 205 and 210 discussed above.

A group of candidate current encoded video frames corresponding to the group of input video frames may then be obtained, e.g., from the video encoder 105 (an operation corresponding to block 215). This operation can also be implemented in substantially the same manner as the implementation of block 215 that was described above, with a larger memory area being used for holding the plurality (rather than a single) candidate current encoded video frames. The group of candidate current encoded video frames corresponding to the group of input video frames can be evaluated to determine whether they meet an encoding criterion.

This operation can be implemented substantially in the same manner as the implementation of block 220, and, for example, the encoding criterion can relate to some statistical measure computed over the group of candidate current encoded video frames. Examples of encoding criteria which may be used include, an average of video quality measure, an average frame size in bits, an average bit rate, an average number of Intra mode macroblocks, an average number of skipped macroblocks, which can be computed over the plurality of candidate current encoded video frames in the group of candidate current encoded video frames. It would be appreciated that for each of these criteria, ‘average’ can also imply a weighted average, minimum, maximum or sum of the values per frame. It would be also appreciated that further examples of encoding criteria which can be used to evaluate the group of candidate current encoded video frames can include the extent of variability between the frames in criteria such as quality or bit-rate.

According to examples of the presently disclosed subject matter, in case it is determined that the group of candidate current encoded video frames does not meet the encoding criterion, the reserved state is copied back to the video encoder 105 (an operation corresponding to block 225). It would be appreciated that this operation can reset the state of the encoder 105 back to the encoder's state prior to encoding the first input video frame in the group of current input video frames. It is possible to implement an operation that is similar to the operation in block 230, to reconfigure the encoder to re-encoder the group of current input video frames using a different encoding parameter, substantially as was described above with reference to block 230.

According to examples of the presently disclosed subject matter, the process of reserving a state of the encoder prior to the first input video frame in the group input video frames, evaluating the group of candidate current encoded video frames, and resetting the state of the encoder in case the group of candidate current encoded video frames does not meet an encoding criterion, to allow a further iteration of this sequence can continue until a group of candidate current encoded video frames meets the encoding criterion. When a group of candidate current encoded video frames, after one or more iterations (e.g., two, three, . . . , N iterations), meets the encoding criterion, the iterative process can end (an operation corresponding to block 235). According to examples of the presently disclosed subject matter, the selected group of current encoded video frames can be appended to the previously encoded frame(s), and is thus placed in the output bitstream.

So far, the examples described related to enabling iterative encoding of a video frame by a video encoder. While the above examples can be implemented with respect to a plurality of video encoders, a separate process will be used for interacting with each one of the plurality of video encoders, and each such separate process deals with each encoder separately and independently. The following description provides examples of a further aspect of the presently disclosed subject matter, which involves enabling parallel encoding by a plurality of video encoders of a given video frame. In this aspect, the interaction with a plurality of encoders is a key feature of the process, as will be apparent from the description below. It would be appreciated that the a plurality of video encoders can include any number of encoder from two and up (e.g., two, three, . . . , N encoders).

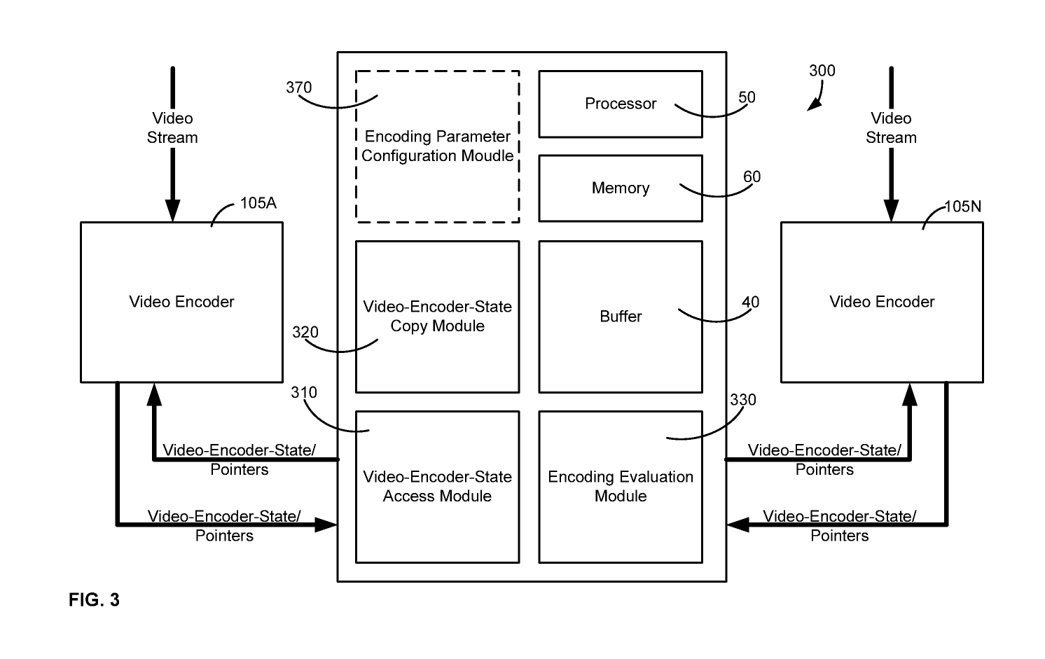

Reference is now made to FIG. 3, which is a block diagram illustration of a device for enabling parallel encoding by a plurality of video encoders of a given video frame, according to examples of the presently disclosed subject matter. According to examples of the presently disclosed subject matter, the device 300 for enabling parallel encoding by a plurality of video encoders 105A-105N of a given video frame can include: a processor 50, a memory 60, a video-encoder-state access module 310, a video-encoder-state copy module 320, and an encoding evaluation module 330. The processor 50 and memory unit 60, in cooperation with the other components of the device 100, can be operable for initiating and/or executing the method of enabling parallel encoding by a plurality of video encoders of a given video frame, as will be described herein. The processor 50 and memory 60 can be any commercially available or yet to be devised processing and memory units, respectively.

Each one of the video encoders 105A-105N can be any presently available or yet to be devised video encoder, including but not limited to the following: H.264 video encoder, X.264 video encoder, H.261 video encoder, H.263 video encoder, MPEG-1 video encoder, MPEG-2 video encoder, MPEG-4 video encoder, WebM video encoder, VP8 video encoder, Adobe Flash video encoder, Sorenson video encoder, Main Concept video encoder.

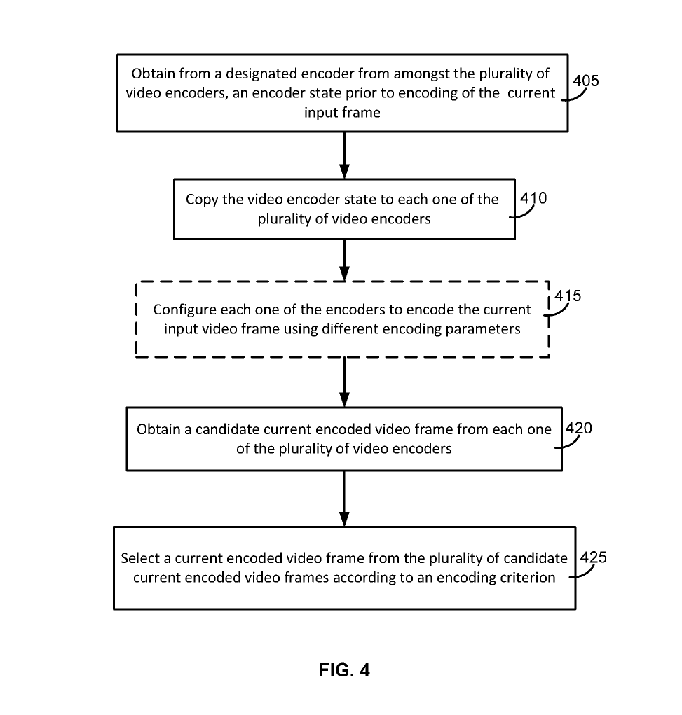

Reference is now additionally made to FIG. 4, which is a flowchart illustration of a method of enabling parallel encoding by a plurality of video encoders of a given video frame, according to examples of the presently disclosed subject matter. FIG. 4 illustrates a process that is implemented for a given current input frame. It should be appreciated that this process can be implemented for each input video frame in a given video stream.

According to examples of the presently disclosed subject matter, for a given current input video frame, a video encoder state resulting from encoding of a previous input video frame and previous to encoding of a current input video frame can be obtained from a designated video encoder from among the plurality of video encoders 105A-105N with which the device 300 is associated (block 405).

For example, the video-encoder-state access module 310 can be operatively connectable to each one of the plurality of video encoders 105A-105N, and given a certain current input video frame, the video-encoder-state access module 310 can be configured to access the video encoder state for the current input video frame in a selected one of the plurality of video encoders 105A-105N. In some examples of the presently disclosed subject matter, the selection from amongst the plurality of video encoders 105A-105N of the video encoder whose state is to be accessed (and copied) can be implemented as part of the process, and shall be described in further detail below. It would be also appreciated that for the first input video frame, the selection can be arbitrary. As mentioned above, the video encoder state for the current input video frame is the designated video encoder's state following the encoding of a previous input video frame and previous to encoding of the current input video frame.

The accessing of a video encoder's state for a given current input frame can be carried out in substantially the same manner as the corresponding access operation that was described above with reference to the process illustrated by FIG. 92 The accessing of a video encoder's state for a current input frame was described above, and the video-encoder-state access module 310 can operate substantially in the same manner to access the designated video encoder's state for the current input frame. The video-encoder-state access module 310 can receive an indication which identifies which one of the plurality of video encoders 105A-105N is the designated video encoder whose encoder state is to be accessed (and copied) for the current input frame.

According to examples of the presently disclosed subject matter, the video encoder state for the current input frame can be copied from the designated video encoder (block 410). For convenience, throughout the description and in the claims, the copy of the video encoder state of a given current input frame is referred to as the reserved state. According to examples of the presently disclosed subject matter, the video-encoder-state copy module 320 is responsible for creating the reserved state for the current input video frame. The copying of a video encoder's state for a given current input frame can be carried out in substantially the same manner as the corresponding copy operation that was described above with reference to the process illustrated by FIG. 2. As was also mentioned above, the accessing and the copying of the encoder's state for the current input frame can be implemented as two separate operations or as a single operation, and in the latter case one of the video-encoder-state access module 310 and the video-encoder-state copy module 320 can be omitted.

Continuing with the description of FIG. 4, optionally each one of the plurality of video encoders with which the device 400 is associated can be configured with a different encoding parameter (block 415). By way of example, the device 400 can include an encoding parameter configuration module 470 that is adapted to configure each one of the plurality of video encoder 105A-105N with which it is associated to use a different encoding parameter(s) for encoding the current input frame. By way of example, the encoding parameter configuration module 470 can be adapted to obtain the modified encoding parameters for configuring the video encoders 105A-105N from the group consisting of: Quantization Parameter (QP), encoding mode, frame type (I/B/P), macroblock partitioning mode, Field/Frame mode (MBAFF), placement of intra macroblocks, number of reference frames, or any combination of the above parameters. It would be appreciated that the list of parameters provided herein is non-exhaustive. The configuration of each one of the video encoders can be carried out in substantially the same manner as the corresponding configuration operation that was described above with reference to the process illustrated by FIG. 2.

According to examples of the presently disclosed subject matter, following the encoding of the current input frame by the plurality of encoders 105A-105N, a candidate current encoded video frame can be obtained from each one of the plurality of video encoders 105A-105N (block 420). Thus, a plurality of candidate current encoded video frames can be obtained at block 420. Each one of the plurality of candidate current encoded video frames, is the current encoded version of the current input frame which was generated by a respective one of the plurality of video encoders 105A-105N. It would be appreciated that since each one of the plurality of video encoder had been configured with a different encoding parameter(s) relative to the other encoders, the candidate current encoded video frame can be different from the candidate current encoded video frame that were generated by the other video encoders.

By way of example, the plurality of candidate current encoded video frames can be obtained from the respective plurality of video encoders 105A-105N by the encoding evaluation module 330. The obtaining of a candidate current encoded video frame from each one of the plurality of video encoders can be carried out in substantially the same manner as the corresponding operation for obtaining a candidate current encoded video frame that was described above with reference to the process illustrated by FIG. 2.

According to examples of the presently disclosed subject matter, the plurality of candidate current encoded video frame can be processed to determine which candidate current encoded video frame meets a predefined encoding criterion (block 425). According to examples of the presently disclosed subject matter, the current encoded video frame that meets the predefined encoding criterion becomes (or is selected as) the selected current encoded video frame. Further by way of example, the selected current encoded video frame is the current encoded video frame.

Further by way of example the selected current encoded video frame is used as the encoded output frame for the current input frame. Further by way of example, each one of the other candidate current encoded video frames can be discarded or simply ignored.

According to an example of the presently disclosed subject matter, the predefined encoding criterion can set a certain value and define a desired relation, such that the candidate current encoded video frame that is to be selected from amongst the plurality of candidate current encoded video frames, is the one which presents the closest (or furthest, etc.) relation to the value.

According to examples of the presently disclosed subject matter, the encoding criterion can be associated with any one of the following: a video quality measure, a frame size in bits, a bit rate, number of Intra mode macroblocks, number of skipped macroblocks or combinations thereof.

According to examples of the presently disclosed subject matter, the current input video frame can be used as a reference in the evaluation of the candidate current encoded video frames. Various aspects of each one of the candidate current encoded video frames can be compared with corresponding aspects of the current input video frame. The comparison can be carried out, for example by the encoding evaluation module 330.

Further according to examples of the presently disclosed subject matter, when a candidate current encoded video frame is selected, the video encoder that generated the selected current encoded video frame becomes the designated video encoder for the current encoded video frame. The new designated video encoder remains the designated video encoder until the subsequent current encoded video frame is designated.

As mentioned above, according to examples of the presently disclosed subject matter, the encoding criterion can be associated with a video encoding quality measure, and possibly with a combination of a plurality of video quality measures. Examples of video encoding quality measures that can be used, for example by the encoding evaluation module 330, to evaluate the plurality of candidate current encoded video frames can include (but are not limited to) any one of the following video encoding quality measures: Peak Signal to Noise Ratio (PSNR), Structural SIMilarity (SSIM), Video Quality Metric (VQM), Moscow State University video quality (MSU), Picture Quality Scale (PQS), Perceptual Evaluation of Video Quality (PEVQ), the quality measure described in U.S. Provisional Application No. 61/528,361, filed on Aug. 29, 2011 (sometimes referred to herein as “BBvCQ”), the content of which is hereby incorporated herein in its entirety, or combinations thereof. It would be appreciated that in some examples of the presently disclosed subject matter, any presently known or yet to be devised video encoding quality measure can be used as or as part of a video encoding quality measure.

Further by way of example, in addition to using the corresponding current input frame in the evaluation of the plurality of candidate current encoded video frames, a preceding encoded video frame and a preceding input video frame can also be used. Thus for example, the device 300 can include a buffer 40 in which, for a given current input frame, the preceding encoded video frame and the preceding input video frame can be held. An example of a video quality measure that is based on the processing of a given current (candidate) encoded frame, a corresponding current input frame, a preceding encoded video frame and a preceding input video frame is described in U.S. Provisional Application No. 61/528,361, filed on Aug. 29, 2011 (sometimes referred to herein as “BBvCQ”), the content of which is hereby incorporated herein in its entirety.

According to examples of the presently disclosed subject matter, the process in FIG. 4, can be implemented for each input video frame from an input video frame stream.

However, in further examples of the presently disclosed subject matter, the process in FIG. 4 can also be implemented in respect of a group of input video frames each time, where the group consists of a plurality of video frames (e.g., two, three, . . . , N frames). In this implementation, a device for enabling parallel encoding by a plurality of video encoders of a given group of input video frames, which includes substantially the same components as the device for enabling parallel encoding by a plurality of video encoders of a given video frame 300 can be used.

According to examples of the presently disclosed subject matter, a process of enabling parallel encoding by a plurality of video encoders of a given group of input video frames, can include an operation corresponding to block 405, where given a certain group of current input video frames, a video encoder state resulting from encoding of a previous input video frame and previous to encoding of a current input video frame can be obtained from a designated video encoder from among the plurality of video encoders 105A-105N with which a device for enabling parallel encoding by a plurality of video encoders of a given group of video frames is associated. The video encoder state for the first input video frame in the group can be copied (an operation corresponding to block 410). These operations can be implemented substantially in the same manner as the implementation of blocks 405 and 410 discussed above.

Optionally each one of the plurality of video encoders with which the device is associated can be configured with a different encoding parameter (an operation corresponding to the operation in block 415). Following the encoding by each one of the plurality of video encoders of the group of current input video frames, a corresponding group of candidate current encoded video frames can be obtained from each one of the plurality of video encoders (an operation corresponding to the operation in block 420). The groups of candidate current encoded video frames from each of the plurality of video encoders can be evaluated to select one of the plurality of groups of candidate current encoded video frames that meets a predefined encoding criterion. This operation can be implemented substantially in the same manner as the implementation of block 425, and, for example, the encoding criterion can relate to some statistical measure computed over each group of candidate current encoded video frames. Examples of encoding criteria which may be used includes, an average of video quality measure, an average frame size in bits, an average bit rate, an average number of Intra mode macroblocks, an average number of skipped macroblocks, which can be computed over the plurality of candidate current encoded video frames in the group of candidate current encoded video frames. It would be appreciated that for each of these criteria, ‘average’ can also imply a weighted average, minimum, maximum or sum of the values per frame.

It would be appreciated that further examples of encoding criteria which can be used to evaluate the groups of candidate current encoded video frames can include the extent of variability between the frames in criteria such as quality or bitrate.

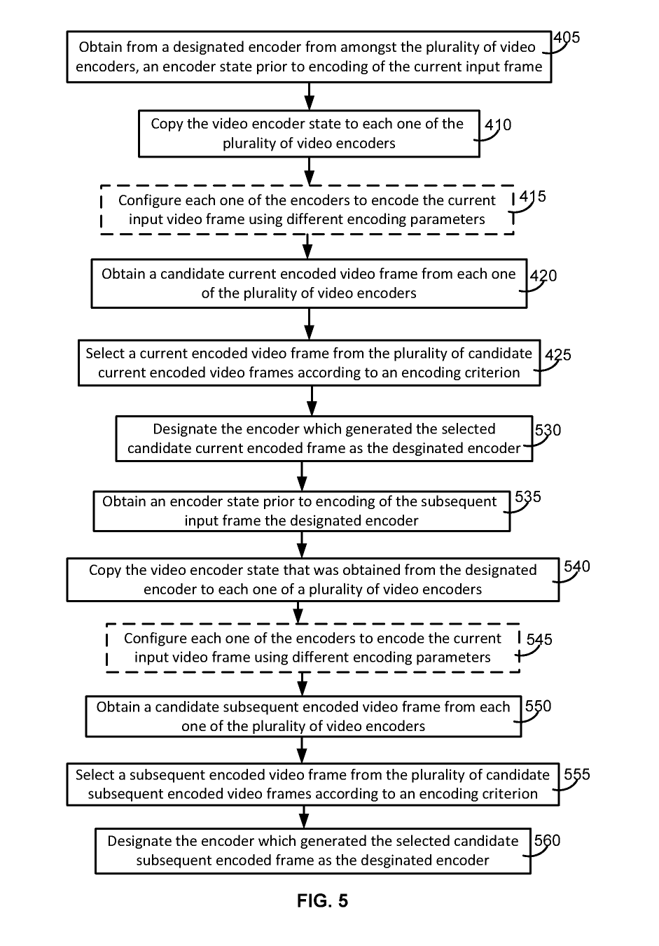

In order to gain a better understanding of a multi-frame implementation of the method of enabling parallel encoding by a plurality of video encoders of a given video frame shown in FIG. 4, reference is now made to FIG. 5, which is a flow chart illustration of certain features of the method of enabling parallel encoding by a plurality of video encoders of a given video frame when applied to a current input frame and to a subsequent input frame, in according with examples of the presently disclosed subject matter. In FIG. 5, for a current input frame, the process follows blocks 405-425 that were shown in FIG. 4 and described above with reference thereto.

Block 530 adds the designation of the video encoder (from amongst the plurality of video encoders 105A-105N) which generated the selected current encoded frame (for the current input frame) as the designated video encoder.

According to examples of the presently disclosed subject matter, once a current encoded video frame is selected, the selected current encoded video frame is obtained from the video encoder which generated it. According to examples of the presently disclosed subject matter, the selected current encoded video frame is appended to the previously encoded frame(s), and is thus placed in the output bitstream. The output of the encoders other than the encoder which produced the selected current encoded frame can simply be dropped, e.g., not written anywhere. As will be described herein, according to examples of the presently disclosed subject matter, the state of the other encoders is to be reset before encoding of a subsequent input frame.

At block 535, a candidate encoded frame selection process for a subsequent input video frame begins. Initially, the encoder state is copied from the designated encoder (block 535). As mentioned above, the designated encoder is the encoder which generated the candidate current encoded video frame that was selected as the current encoded video frame (where current is previous to the subsequent input video frame). Thus, the video encoder state resulting from encoding of a current (or previous relative to the subsequent input video frame) video input video frame and previous to encoding of a current subsequent input video frame.

The obtained video encoder state can be copied to each of the other video encoders (block 540). It would be appreciated that by copying the video encoder state from the designated video encoder to each of the other video encoders, the plurality of encoders can be placed in a common state, which is the state of the designated encoder following the encoding of the current input video frame, and from this point the processing of the subsequent input video frame can begin. In this manner, the plurality of video encoders are updated with the correct state data, which is obtained for each input video frame from the video encoder that was selected to provide the previous encoded frame. It would be appreciated that resetting the state of the encoders which did not provide the selected current encoded video frame can be required to maintain consistency with the part of the video stream that was encoded thus far, to which the encoded video frames are appended.

According to examples of the presently disclosed subject matter, following the copying of the obtained video encoder state from the designated video encoder to each of the other video encoders, blocks 545-555 which are essentially repetition of blocks 425, 530 and 535 for a plurality of candidate subsequent encoded frames and can be implemented in a similar manner. Likewise, block 560 in which the video encoder (from amongst the plurality of video encoders 105A-105N) which generated the selected subsequent encoded frame (for the subsequent input frame) is designated as the designated video encode is similar in implementation to block 530 which was described above.

It would be appreciated that while the processes were described here with reference to one or two frames, they can be likewise applied to any number of frames (e.g., one, two, three, . . . , N). [0116] It would be appreciated that operations that are similar to the operations in block 530-560 can be implemented as part of the process of enabling parallel encoding by a plurality of video encoders of a given group of input video frames, which was described above.

For example, an operation that is substantially identical to the operation in block 530 can be carried out to designate the video encoder from amongst the plurality of video encoders which generated the selected group of current encoded frames. An operation which corresponds to the operation in block 535 can be implemented to copy the encoder state from the designated encoder (block 535). An operation which corresponds to the operation in block 540 can be implemented to copy the obtained video encoder state to each of the other video encoders.

Following the copying of the obtained video encoder state from the designated video encoder to each of the other video encoders, and the ensuing encoding of a group of subsequent input video frames, the groups of subsequent candidate encoded video frames from each of the plurality of video encoders can be evaluated to select one of the plurality of groups of subsequent candidate encoded video frames that meets a predefined encoding criterion. This operation can be implemented substantially as was described above with respect to the candidate current encoded video frames, and can be followed by a designation of the encoder which generated the selected group of subsequent candidate encoded video frames, etc., etc.

It will also be understood that the device according to the invention can be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1-42. (canceled)

43. A method of enabling iterative encoding of a video frame by a video encoder, comprising:
obtaining a video-encoder-state resulting from encoding of a previous input video frame and previous to encoding of a current input video frame; copying the video-encoder-state giving rise to a reserved state; and obtaining a candidate current encoded video frame from the video encoder, and in case the candidate current encoded video frame does not meet an encoding criterion, copying the reserved state back to the video encoder to enable the video encoder to re-encode the current input video frame.

44. The method according to claim 43, further comprising configuring the encoder to re-encode the current input video frame using different encoding parameters than the encoding parameters that were used to obtain the candidate current encoded video frame.

45. The method according to claim 44, wherein the encoding parameters are selected from a group consisting of: Quantization Parameter (QP), encoding mode, frame type (I/B/P), Macroblock partitioning mode, Field/Frame mode (MBAFF), placement of intra macroblocks, number of reference frames.

46. The method according to claim 43, wherein the encoding criterion is selected from a group consisting of: a video quality measure, frame size in bits, bit rate, number of Intra mode macroblocks, number of skipped macroblocks.

47. A method of enabling parallel encoding of a video frame, comprising:
obtaining a video-encoder-state resulting from encoding of a previous input
video frame and previous to encoding of a current input video frame;
copying the video-encoder-state to each one of a plurality of video encoders;
obtaining a candidate current encoded video frame from each one of the plurality of video encoders, giving rise to a plurality of candidate current encoded video frames; and
selecting a current encoded video frame from the plurality of candidate current encoded video frames according to an encoding criterion.

48. The method according to claim 47, comprising, for a subsequent input video frame:
obtaining, from the video encoder that provided the selected current encoded video frame, the video-encoder-state resulting from encoding of the current input video frame;
previous to encoding of the subsequent input video frame, copying to each one of a plurality of video encoders, the selected video-encoder-state resulting from encoding of the current input video frame;
obtaining a subsequent candidate encoded video frame from each one of the plurality of video encoders, giving rise to a plurality of subsequent candidate encoded video frames; and
selecting a subsequent encoded video frame from the plurality of subsequent candidate encoded video frames according to an encoding criterion.

49. The method according to claim 47, further comprising: configuring each one of the plurality of video encoders to use different encoding parameters for encoding the current input video frame.

50. The method according to claim 49, wherein said configuring comprises selecting an encoding parameter that differs among the plurality of video encoders from a group consisting of: Quantization Parameter (QP), encoding mode, frame type (I/B/P), Macroblock partitioning mode, Field/Frame mode (MBAFF), placement of intra macroblocks, number of reference frames.

51. The method according to claim 47, wherein the encoding criterion is selected from a group consisting of: a video quality measure, frame size in bits, bit rate.

52. A device for enabling iterative encoding of a video frame by a video encoder, comprising:
a video-encoder-state access module adapted to obtain a video-encoder-state resulting from encoding of a previous input video frame and previous to encoding of a current input video frame;
a video-encoder-state copy module configured for copying the video-encoder state giving rise to a reserved state; and
an encoding evaluation module adapted to obtain a candidate current encoded video frame for evaluating the quality thereof using an encoding criterion, wherein in case the candidate current encoded video frame does not meet an encoding criterion, the video-encoder-state copy module is configured to copy the reserved state back to the video encoder to enable the video encoder to re-encode the current input video frame.

53. The device according to claim 52, further comprising an encoding parameter configuration module that is adapted to configure the encoder to re-encode the current input video frame using different encoding parameters than the encoding parameters that were used to obtain the candidate current encoded video frame.

54. The device according to claim 53, wherein said encoding parameter configuration module is configured to select the encoding parameters from a group consisting of: Quantization Parameter (QP), encoding mode, frame type (I/B/P), Macroblock partitioning mode, Field/Frame mode (MBAFF), placement of intra macroblocks, number of reference frames.

55. The device according to claim 52, wherein said encoding evaluation module is configured to select the encoding criterion from a group consisting of: a video quality measure, frame size in bits, bit rate, number of Intra mode macroblocks, number of skipped macroblocks.

56. A device for enabling parallel encoding of a video frame, comprising:
a video-encoder-state access module adapted to obtain a video-encoder-state resulting from encoding of a previous input video frame and previous to encoding of a current input video frame;
a video-encoder-state copy module configured for copying the video-encoder state to each one of a plurality of video encoders;
an encoding evaluation module adapted to obtain a candidate current encoded video frame from each one of the plurality of video encoders, giving rise to a plurality of candidate current encoded video frames, and is further adapted to select a current encoded video frame from the plurality of candidate current encoded video frames according to an encoding criterion.

57. The device according to claim 56, for a subsequent input video frame:
said video-encoder-state access module is adapted to obtain from the video encoder that provided the selected current encoded video frame the
video encoder-state resulting from encoding of the current input video frame, and previous to encoding of the subsequent input video frame;
said video-encoder-state copy module is configured to copy, to each one of a plurality of video encoders, the selected video-encoder-state resulting from encoding of the current input video frame; and
said encoding evaluation module is adapted to obtain a candidate subsequent encoded video frame from each one of the plurality of video encoders,
giving rise to a plurality of candidate subsequent encoded video frames, and is further adapted to select a subsequent encoded video frame from the plurality of candidate subsequent encoded video frames according to an encoding criterion.

58. The device according to claim 56, further comprising an encoding parameter configuration module that is adapted to configure each one of the plurality of video encoders to use different encoding parameters for encoding the current input video frame.

59. The device according to claim 58, wherein said encoding parameter configuration module is adapted to select the encoding parameters that differ among the plurality of video encoders from a group consisting of: Quantization Parameter (QP), encoding mode, frame type (I/B/P), Macroblock partitioning mode Field/Frame mode (MBAFF), placement of Intra macroblocks, number of reference frames.

60. The device according to claim 56, wherein said encoding evaluation module is configured to select the encoding criterion from a group consisting of: a video quality measure, frame size in bits, bit rate.

61. A program storage device readable by machine, tangibly embodying a program of instructions executable by the machine to perform a method of enabling iterative encoding of a video frame by a video encoder, comprising:
obtaining a video-encoder-state resulting from encoding of a previous input video frame and previous to encoding of a current input video frame;
copying the video-encoder-state giving rise to a reserved state; and
obtaining a candidate current encoded video frame from the video encoder, and in case the candidate current encoded video frame does not meet an encoding criterion, copying the reserved state back to the video encoder to enable the video encoder to re-encode the current input video frame.

62. A program storage device readable by machine, tangibly embodying a program of instructions executable by the machine to perform a method of enabling parallel encoding of a video frame, comprising:
obtaining a video-encoder-state resulting from encoding of a previous input video frame and previous to encoding of a current input video frame;
copying the video-encoder-state to each one of a plurality of video encoders;
obtaining a candidate current encoded video frame from each one of the plurality of video encoders, giving rise to a plurality of candidate current encoded video frames; and
selecting a current encoded video frame from the plurality of candidate current encoded video frames according to an encoding criterion.
